(19) United States
(12) Patent Application Publication
(10) Pub. No.: US 2019/0358101 A1
(43) Pub. Date: Nov. 28, 2019

(54) SAFETY APPARATUS FOR TRANSPORTING MEDICAL PATIENTS

(71) Applicant: Soteria Transporters LLC, Millwood, VA (US)

(72) Inventors: Fritz Steuer, Millwood, VA (US); Erik Quigg, Charlottesville, VA (US)

(21) Appl. No.: 16/421,051

(22) Filed: May 23, 2019

Related U.S. Application Data
(60) Provisional application No. 62/675,627, filed on May 23, 2018.

(51) Int. Cl. A61G 1/04; F16F 15/00; A61G 11/00; A61G 1/02; G10K 11/178

(52) U.S. Cl. CPC A61G 1/042; F16F 15/002; A61G 11/008; F16F 2230/0011; A61G 1/0237; G10K 11/178; A61G 11/009

(57) ABSTRACT

A transport incubator comprising an incubator, frame, and supporting components. The incubator is self-leveling, vibrationally isolated, and features active noise canceling or reduction. The frame is composed of lightweight composites and features composite air tanks.

### CROSS-REFERENCE TO RELATED APPLICATIONS

The present application relies on the disclosure of and claims priority to and the benefit of the filing date of U.S. Provisional Application No. 62/675,627, filed on May 23, 2018, the disclosure of which is hereby incorporated by reference herein in its entirety.

### BACKGROUND

### Field of the Invention

Embodiments of the invention are directed to a lightweight, vibrational isolating, self-leveling, light canceling and/or reducing, active noise & vibration canceling and/or reducing, transport incubator that minimizes outside stimulus to a patient. Embodiments provide protection and/or minimization from outside stressors including high noise levels, vibrations, physical forces, and light, while offering easy access to the patient. Embodiments taught herein significantly decrease the chance of transport-related injuries for patients, especially infants, while improving ease of use for the medical staff caring for the patient.

### Description of the Related Art

Every year, thousands of newborns are transported from remote areas to highly specialized Neonatal Intensive Care Units (NICUs). Current transport vehicles are extremely weight sensitive and limited in space. Additionally, transportation can be highly damaging to a preterm child's health. The vibrations and forces experienced during transport have been found to increase health risks, specifically for intraventricular hemorrhage (IVH), and primary pulmonary hypertension (PPH) in the infant. This trauma can result in long term brain damage or even death.

Conventional transport incubators have a multitude of problems that can both damage the child, and slow medical staff in executing their efforts. Typically, such incubators are heavy and cumbersome due to their construction. Due to a limited number of ports, these transport incubators limit the child, and prevent medical staff from executing important medical procedures. Current transport incubators do little to mitigate vibrations, noise, and offer little means of maintaining the infant at a certain angle or orientation.

Other incubators exist which are constructed of light-weight composites that improve ease of use for medical staff. These incubators seek to minimize vibrations via a vibrationally dampened connection to a chassis, and improve access to the child with a uniquely shaped incubation chamber (see UK Patent Application Publication No. GB2389535A). These designs, however, lack, for example, the self-leveling system, noise reducing technology, active vibration reducing, smart film integration, and hinged door system, as taught by embodiments of the invention. Embodiments as described herein would further isolate the child from external vibrations and the self-leveling system would allow medical staff to safely tilt the child at any desired angle.

Additionally, isolation devices for shock reduction in a neonatal transport apparatus exist. For example, certain devices propose using a series of gas cylinders to reduce the shock transferred to a child (see US Patent Application Publication No. 2007/0089236). However, unlike the device taught herein, previous efforts, such as that in US Patent Application Publication No. 2007/0089236, teach methods to reduce vibrations to an infant, not a full incubator. Moreover, similar devices do not incorporate self-leveling technology, and thus would not effectively protect the child to the extent of the current invention.

Smart incubator glass in certain devices proposes using a sensor-based system configured to detect light transmitted and adjust light transparency. However, unlike the device taught herein, previous efforts, such as those described in US Patent Application Publication No. 2015/0073204, teach methods to reduce light levels via sensors. These efforts do not incorporate the use of films to display information or provide privacy for the patient during transport. Further, these devices do not allow personnel to control individual panels throughout the incubator, allowing only desired sections of the incubator to be opaque or tinted.

Previous devices utilize noise canceling systems for an incubator. However, unlike the device taught herein, devices such as those described in US Patent Application Publication No. 2014/0003614 are only configured to protect a patient from ambient noises in a hospital, and only in or around the patient's head. Previous devices are specifically designed to reduce the noise created by internal mechanisms such as fans and ventilators, and not from exterior noises created by transportation. Additionally, the accelerometers are only calibrated with internal vibrations. The device taught herein is specifically designed and configured to compensate for vibration of the microphone(s) caused by transport, specifically for low frequency sounds created by ambulance and helicopter transportation. The device taught herein protects the entire body of the patient via optimally-placed speakers around the full incubator, offering greater protection over previous devices.

### SUMMARY

Embodiments of the invention provide a compact and lightweight infant incubator device. In embodiments, the device eliminates adverse vibrations and other forms of harm to the patient, such as an infant or young child, and allows for safer transport than what is currently practiced by even sophisticated medical facilities.

In one exemplary embodiment, a transport incubator is provided that completely or partly isolates the patient from most or all external stressors. For example, the incubator includes a containment portion that is self-levelling and in whole or in part vibrationally isolating.

In another embodiment, a medical transport system is provided that enables for the carrying bed of the incubator to be inclined or declined at an angle, and raised or lowered, to comfort the patient or provider for easier access by medical professionals to the patient.

A preferred embodiment maintains a set temperature and/or humidity inside the containment portion of the incubator while still being compact enough for transport in, for example, an ambulance, helicopter, or other vehicle. In aspects, the containment portion of the incubator maintains a noise cancellation or reduction zone through the use of active noise canceling technology. Additionally, in embodiments, the incubator and/or containment unit maintains a vibration canceled or reduced cradle through the use of active vibration canceling, such as active noise control (known as “ANC”). In preferred embodiments, the base frame of the incubator is composed of a light-weight composite, such as carbon fiber, in order to minimize weight. In one embodiment, dual hinged doors and/or access doors allow access to the patient, while still maintaining the internal environment when said doors are closed and/or sealed. Additionally, the device provides an oxygen source for the patient, which may be made of composite materials to further reduce weight. In aspects, the incubator may be powered from a battery and may be self-powered so it can be used in rural areas or in unusual conditions, and/or while during transportation. In addition, medical equipment, such as IV pumps, ventilators, and other, for example, newborn intensive care unit (NICU)-specific tools and components, can be located on or near or affixed to the incubator unit.

In one embodiment, the patient is secured inside the incubator during transport; for example, by using straps, foam, padding, or other safe and effective means for stabilizing the patient during transport without adding stressors.

In another embodiment, the incubator allows for easy access to the entirety of the interior of the incubator to provide for cleaning and sterilization of the interior containment portion.

In another embodiment, an enclosed containment portion is provided that is isolated or partially protected from outside light using smart film technology, such as polymer-dispersed liquid crystal. Based on the needs of the medical staff attending to the patient, the light may be quickly and automatically adjusted, and individual panels are able to be made opaque, partially transparent, or transparent, depending on the patient's or the medical staffs' needs.

An embodiment is compatible with current transport methods, and is able to be used in standard ambulances, helicopters, and aircraft.

Yet another embodiment displays patient vital signs to the medical staff at or near the incubator, or remotely from the incubator. The device may relay this information to a hospital while undergoing transport, such as the hospital where the patient left from or where the patient is expected to arrive.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 depicts a self-leveling, vibrationally isolated, and noise & vibration canceling transport incubator according to an embodiment.

FIG. 2 illustrates an exemplary gimballing system and vibrational isolation systems according to an embodiment.

FIG. 3 shows a gimballing system, and highlights the composite materials for weight reduction according to another embodiment.

FIG. 4 shows a self-leveling and vibrationally isolated, and noise canceling transport incubator, according to another embodiment.

FIG. 5 depicts electrical actuators that maintain a level incubation space according to an embodiment.

FIG. 6 shows an example of the smart film light blocking system that may be used as part of an embodiment of the invention.

### DETAILED DESCRIPTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Embodiments comprising various features may also consist of or consist essentially of those various features. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention. All references cited in this specification are hereby incorporated by reference in their entireties.

Embodiments of the invention also include a computer readable medium comprising one or more computer files comprising a set of computer-executable instructions for performing one or more of the calculations, steps, processes and operations described and/or depicted herein. In exemplary embodiments, the files may be stored contiguously or non-contiguously on the computer-readable medium. Embodiments may include a computer program product comprising the computer files, either in the form of the computer-readable medium comprising the computer files and, optionally, made available to a consumer through packaging, or alternatively made available to a consumer through electronic distribution. As used in the context of this specification, a “computer-readable medium” is a non-transitory computer-readable medium and includes any kind of computer memory such as floppy disks, conventional hard disks, CD-ROM, Flash ROM, non-volatile ROM, electrically erasable programmable read-only memory (EEPROM), and RAM. In exemplary embodiments, the computer readable medium has a set of instructions stored thereon which, when executed by a processor, cause the processor to perform tasks, based on data stored in the electronic database or memory described herein. The processor may implement this process through any of the procedures discussed in this disclosure or through any equivalent procedure.

In other embodiments, files comprising the set of computer-executable instructions may be stored in computer-readable memory on a single computer or distributed across multiple computers. A skilled artisan will further appreciate, in light of this disclosure, how the invention can be implemented, in addition to software, using hardware or firmware. As such, as used herein, the operations of the invention can be implemented in a system comprising a combination of software, hardware, or firmware.

Embodiments of this disclosure include one or more computers or devices loaded with a set of the computer-executable instructions described herein. The computers or devices may be a general purpose computer, a special-purpose computer, or other programmable data processing apparatus to produce a particular machine, such that the one or more computers or devices are instructed and configured to carry out the calculations, processes, steps, operations, algorithms, statistical methods, formulas, or computational routines of this disclosure. The computer or device performing the specified calculations, processes, steps, operations, algorithms, statistical methods, formulas, or computational routines of this disclosure may comprise at least one processing element such as a central processing unit (i.e. processor) and a form of computer-readable memory which may include random-access memory (RAM) or read-only memory (ROM). The computer-executable instructions can be embedded in computer hardware or stored in the computer-readable memory such that the computer or device may be directed to perform one or more of the calculations, steps, processes and operations depicted and/or described herein.

Additional embodiments of this disclosure comprise a computer system for carrying out the computer-implemented method of this disclosure. The computer system may comprise a processor for executing the computer-executable instructions, one or more electronic databases containing the data or information described herein, an input/output interface or user interface, and a set of instructions (e.g. software) for carrying out the method. The computer system can include a stand-alone computer, such as a desktop computer, a portable computer, such as a tablet, laptop, PDA, or smartphone, or a set of computers connected through a network including a client-server configuration and one or more database servers. The network may use any suitable network protocol, including IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in memory that is operably connected to an internal electronic database. The central computer may perform the computer-implemented method based on input and commands received from remote computers through the internet. The central computer may effectively serve as a server and the remote computers may serve as client computers such that the server-client relationship is established, and the client computers issue queries or receive output from the server over a network.

The input/output interfaces may include a graphical user interface (GUI) which may be used in conjunction with the computer-executable code and electronic databases. The graphical user interface may allow a user to perform these tasks through the use of text fields, check boxes, pull-downs, command buttons, and the like. A skilled artisan will appreciate how such graphical features may be implemented for performing the tasks of this disclosure. The user interface may optionally be accessible through a computer connected to the internet. In one embodiment, the user interface is accessible by typing in an internet address through an industry standard web browser and logging into a web page. The user interface may then be operated through a remote computer (client computer) accessing the web page and transmitting queries or receiving output from a server through a network connection.

In a preferred embodiment, a transport incubator is provided to isolate a neonate or infant from a variety of external stimuli, including, but not limited to, noise, vibrations, and light. It also features hinged doors, allowing medical staff improved access to the patient while attending to relevant medical needs. This allows for improved care and enables easier performance of necessary procedures.

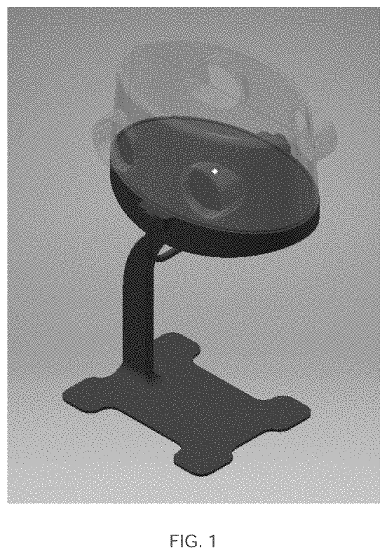

Turning to FIG. 1, a transport incubator, levelled, for example, through a gimballing system is shown. An isolette attaches to the gimballing arm(s) system, which is linked to the frame base. In preferred embodiments, the structure and components are constructed of a lightweight composite material, such as carbon fiber, in order to minimize weight for easier use and transportation. In the base of the isolette, a warming and/or cooling system is provided in order to maintain constant or desired temperature and/or humidity in the patient area.

Additionally, a battery may be located inside of or near the base of the isolette, or elsewhere, allowing for power when the incubator is not plugged into an ambulance, helicopter, hospital, or other source of electricity. On top of the base, a patient mattress to support the infant may be located. The mattress may be made of a material that is an easily cleanable and/or sterilizable material, such as anti-bacterial fiber. Additional equipment, such as IV pumps and air tanks may added to the frame base or elsewhere on the incubator apparatus. In a preferred embodiment, a double layered, acrylic covering encloses the patient area. This covering insulates the patient space, allowing for a microenvironment to be maintained according to the needs of the patient or requirements of the attending medical professionals. Ports on the acrylic covering may allow for access to the child, or closed and/or sealed when not in use. This further helps maintain the internal, maintained environment.

In aspects, noise to the patient may be minimized through an insulating single, double, or multiple layer covering all or part of the containment portion of the incubator. In a preferred embodiment, noise not eliminated or sufficiently reduced by the covering layer is further eliminated or reduced by active noise canceling/reducing speakers in or near the patient compartment. In aspects, a sensor on the outside or on the inside of the isolette detects noise being produced from the outside environment. In response, speakers in or near the patient area may produce soundwaves 180 degrees out of phase of the noise soundwaves, creating a sonically isolated area around the patient, canceling or reducing out any harmful vibrations caused by the noise.

In a preferred embodiment, inside the isolette, under the stage for the patient, may be included a fan, cooling element, cooling apparatus, heating element, heating apparatus, and/or water or other liquid reservoir. This allows for air of a specific temperature and/or humidity to be pumped or otherwise put into the patient area. Temperature and/or humidity inside the patient area may be maintained in two fashions, by way of example only. One method, for example, is setting a specific temperature and/or humidity setting. The second method, for example, is a thermometer that is placed on the skin of a patient. The system is able to dynamically react to changes to a patient's body temperature in order to fluctuate the temperature and/or humidity in the containment unit to treat the patient and/or serve the needs/requirements of the attending medical professionals.

In embodiments, air tanks may be attached to the frame base or near the frame base. Tubing and/or hosing or other means would allow air and/or gas into the patient area in order to supply oxygen or other common medical gases to the patient. The tubing and/or hosing may be slack or taught in order to allow for preferable movement of the gimbal system. The air tanks may be constructed of a light composite material. In embodiments, an oxygen sensor or other gas sensor would be located in or near the patient area to allow for real time or near real time sensing of oxygen or other gas levels. Oxygen or other gas levels can be dynamically, immediately, or periodically altered in response to the patient's need, the medical professionals' decisions, or computer generated determinations.

In a preferred embodiment, at the corners of the base of the device taught herein are four means of mobility, such as wheels, and preferably caster wheels, although the device may be made mobile in other ways, such as by placing on a gurney, by carrying, or by otherwise moving from one location to another. In embodiments, the wheels have rubber or other cushioning spacers where the wheels attach to the frame to further isolate the system from vibrations.

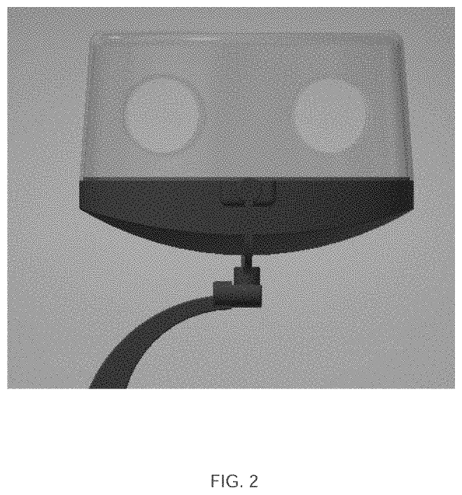

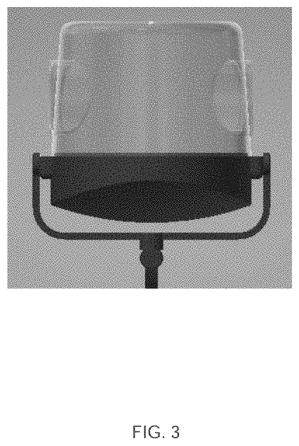

FIGS. 2 and 3, in particular, detail the self-leveling gimballing system as specifically taught by embodiments of the invention. In aspects, a first motor in the isolette may allow for pitch control. The first motor may attach to a first gimballing arm, for example. The first gimballing arm, in this example, may then be attached to a second motor, which is then attached to a second gimballing arm. This second motor may control the yaw angle, or other angle, and/or position of the isolette. The arm(s) may attach to the base of the system, where a possible third motor may allow for roll or other control or position. Such a system as taught herein allows for a three axis gimballed control. In aspects, rubber washers or other structures between each joint prevent vibrations from being transferred from the base to the isolette. In aspects, an accelerometer in or near the isolette connects with a microcontroller in the base or elsewhere, or with a remote electronic device. The accelerometer sends analog or digital or other signals to a microcontroller or electronic device or analog device, which in response may send Proportional-Integral-Derivative (PID) signals, information, and/or instructions to the gimbal motors. This allows the motors to react to movements of the base or other aspect of the system/incubator, and keeps the isolette level or near level.

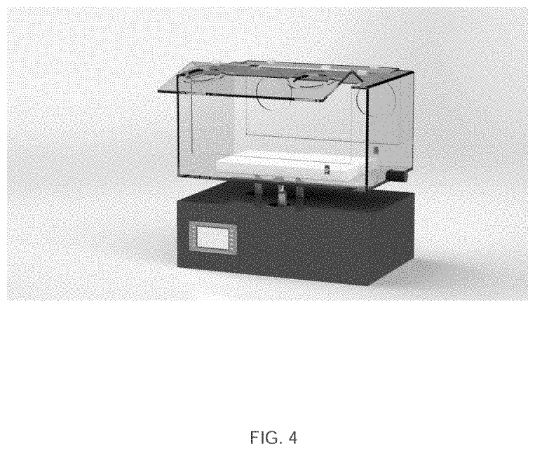

FIG. 4 shows an embodiment of a transport incubator leveled by electronic actuators. The base may be composed of lightweight carbon fiber, which is a preferred embodiment but not a limitation. In the base of the incubator, a warming or cooling system may be provided in order to maintain a constant, near constant, or adjustable temperature and/or humidity in the patient area. Inside of the patient containment area, a mattress may be provided to support the patient. The mattress is preferably made of a material that is easily cleanable and sterilizable, such as anti-bacterial fiber. One or more composite air tanks may be stored inside or near the frame of the incubator apparatus and allow for oxygen or other common medical airs to be pumped or otherwise ventilated into the patient area. Additionally, a battery may be located inside of or near the base, allowing for power when the incubator is not plugged into a power supply, such as in an ambulance, helicopter, or hospital. In embodiments, a double layered, acrylic covering encloses the patient area. This insulates the patient space, allowing for a desired temperature and/or humidity to be maintained. In aspects, ports in the acrylic covering allow for access to the patient, and close or are sealed when not in use. Additionally, in a preferred embodiment, dual hinged doors slide up, allowing for access to the patient. If desired, only half can be hinged up, allowing access to a particular side, portion, or part of the patient. If access from the top is needed, the entire door can be opened, as shown in the figures (e.g., FIGS. 4-6). Both doors and access ports close and/or seal when not in use, containing heat, humidity, and gases in the patient containment area. Additional equipment, such as IV pumps can be placed on top of or near the isolette.

In a preferred embodiment, inside the base, a fan, heating and/or cooling element, and/or water or other liquid reservoir are provided. Alone or in combination, these components allow for air of a specific temperature and humidity to be pumped into the patient area. Temperature inside the patient area may be maintained in at least two fashions. One possible method is setting a specific temperature and/or humidity setting. The second method is having a thermometer placed on the skin of the patient. The system is able to dynamically react to changes to a patient's body temperature in an effort to maintain a desired temperature and/or other patient vital signs. In a preferred embodiment, tubing from the base to the isolette allows for air to recycle inside of the patient containment area, and maintains a constant, near constant, and/or desired microenvironment.

Noise to the patient may be minimized by using an insulating double layer. Any remaining noise may be eliminated or further reduced by active noise canceling speakers in the patient compartment. A sensor on the inside and/or outside of the isolette may detect noise being produced from the outside environment. In response, speakers in the patient area produce sound waves 180 degrees out of phase with the noise sound waves, creating a mostly sonically isolated area around the patient canceling out harmful vibrations caused by noise. Any vibrations that reach the patient and/or cradle are then actively canceled by destructive interference. Such technology is embodied by, for example, Bose QuietComfort® 25.

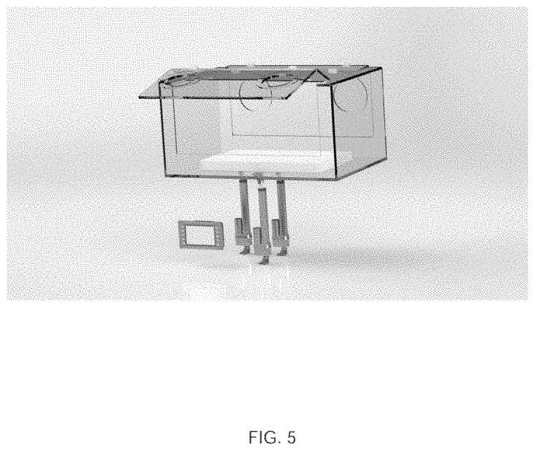

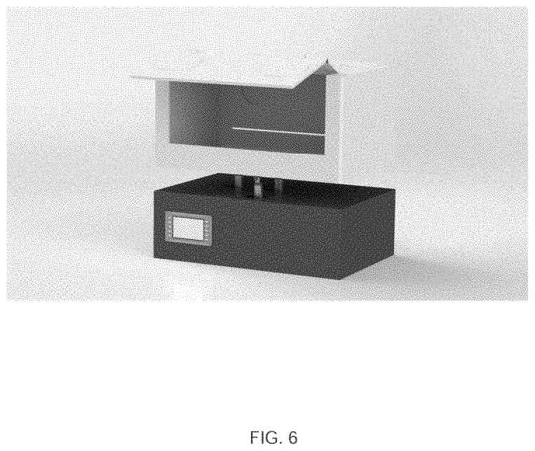

FIG. 5, in particular, shows an isolated view of a preferred embodiment of the electronic actuator self-leveling system. When in transportation, one or more actuators activate, such as three actuators in a preferred embodiment, and raise the isolette up. In the central actuator a universal joint may be provided, allowing the isolette to rotate in three axes or any desired direction and/or orientation. Off center actuators may control both the pitch and the yaw, for example. Elevation of the isolette can be altered using the electronic actuators in order to increase access for the medical staff. Similar to the gimballed system, an accelerometer is disposed in, on, or near the isolette, while a microcontroller may be contained in, on, or near the base. The accelerometer may send analog or digital signals to the microcontroller in response to movement. The microcontroller then sends analog or digital signals to the electronic actuators, which move in response, keeping the isolette level or in a desired location, position, and/or orientation. In aspects, the actuators are attached to the isolette using rubber or otherwise cushioned grommets, dampening the system and preventing vibrations from being transferred into the patient area. FIG. 6 shows an embodiment using smart film. When a voltage is applied to the film, the film becomes transparent or tinted or opaque, allowing for light to enter, or not enter, the patient area. Each panel may be connected to a separate circuit, allowing for individual panels to be blacked out, tinted, or made transparent as desired by the patient or medical staff.

One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A medical transport apparatus, comprising:
a patient containment portion, a base, and one or more arm in communication with the base and the patient containment portion; and
one or more system in operable communication with the base capable of providing leveling, and/or isolating, canceling, and/or reducing vibration, and/or canceling or reducing noise to the patient containment portion.

2. The medical transport apparatus of claim 1, further comprising a covering capable of reducing light transmission therethrough.

3. The medical transport apparatus of claim 2, wherein the covering is capable of being rendered opaque, transmissive, partially transmissive, tinted, and/or wholly or partially transparent.

4. The medical transport apparatus of claim 1, wherein the base comprises a carbon composite material.

5. The medical transport apparatus of claim 1, wherein the one or more system in operable communication with the base comprises a gimballing system.

6. The medical transport apparatus of claim 5, wherein the gimballing system comprises one or more arm in operable communication with one or more motor, which gimballing system is capable of providing for control of one or more of pitch, yaw, roll, or other angle or position of the patient containment portion.

7. The medical transport apparatus of claim 5, wherein the gimballing system comprises:
a first motor in operable communication with the patient containment portion and a first gimballing arm, which first motor is capable of providing for control of a pitch of the patient containment portion;
a second motor in operable communication with the first gimballing arm and a second gimballing arm, which second motor is capable of providing for control of a yaw of the patient containment portion;
wherein the first gimballing arm and the second gimballing arm are in operable communication with the patient containment portion and the base.

8. The medical transport apparatus of claim 7, further comprising a third motor capable of providing for control of a roll of the patient containment portion.

9. The medical transport apparatus of claim 1, wherein the patient containment portion comprises an isolette.

10. The medical transport apparatus of claim 1, wherein the one or more system in operable communication with the base comprises an active noise control system.

11. The medical transport apparatus of claim 10, wherein the active noise control system comprises:
one or more sensor; and
one or more speaker operably configured to produce soundwaves 180 degrees out of phase of soundwaves detected by the sensor.

12. The medical transport apparatus of claim 2, wherein the covering comprises smart film technology.

13. The medical transport apparatus of claim 1, further comprising an oxygen source.

14. The medical transport apparatus of claim 13, wherein the oxygen source is a tank.

15. The medical transport apparatus of claim 1, further comprising one or more medical equipment comprising one or more IV pump, ventilator, or other Newborn Intensive Care Unit tools or components.

16. The medical transport apparatus of claim 1, wherein the base comprises one or more warming and/or cooling system.

17. The medical transport apparatus of claim 1, wherein the base comprises a battery.

18. The medical transport apparatus of claim 1, further comprising one or more insulating single, double, or multiple layer covering the patient containment portion and capable of reducing noise to a patient within the patient containment portion.

19. A gimballing system for a medical transport apparatus, comprising:
a first motor in operable communication with a patient containment portion of the medical transport apparatus and a first gimballing arm, which first motor is capable of providing for control of a pitch of the patient containment portion;
a second motor in operable communication with the first gimballing arm and a second gimballing arm, which second motor is capable of providing for control of a yaw of the patient containment portion;
wherein the first gimballing arm and the second gimballing arm are in operable communication with the patient containment portion and a base of the medical transport apparatus.

20. The gimballing system of claim 19, further comprising a third motor capable of providing for control of a roll of the patient containment portion.
